(19) United States
(12) Patent Application Publication
(10) Pub. No.: US 2024/0052212 A1
(43) Pub. Date: Feb. 15, 2024

(54) PRESSURE-SENSITIVE ADHESIVES FOR A WIDE TEMPERATURE RANGE

(71) Applicant: GCP Applied Technologies Inc., Alpharetta, GA (US)

(72) Inventors: Anthony Maiorana, Arlington, MA (US); Xia Cao, Acton, MA (US); Ralph Fayad, Woburn, MA (US); Marysusan Couturier, Framingham, MA (US); Li Zhang, North Hills, CA (US)

(21) Appl. No.: 18/268,234

(22) PCT Filed: Dec. 14, 2021
(86) PCT No.: PCT/US2021/063402

§ 371 Date: Jun. 18, 2023

Related U.S. Application Data
(60) Provisional application No. 63/127,232, filed on Dec. 18, 2020.

(51) Int. Cl. C09J 7/38; C09J 11/08; C09J 11/06

(52) U.S. Cl. CPC C09J 7/387; C09J 11/08; C09J 11/06; C09J 2301/304; C09J 2301/302; C09J 2301/408; C09J 2301/414; C09J 2400/126; C09J 2453/00; C09J 2491/00

(57) ABSTRACT

A pressure-sensitive adhesive (PSA) composition and method of use across a wide operable temperature window. The PSA composition includes a triblock copolymer rubber with relatively low diblock content, an aliphatic tackifier, an aromatic tackifier, and an oil-based plasticizer. The combination of components results in the PSA having a phase-separated morphology, where the PSA includes two domains that do not mix with each other. This morphology’ results in superior performance of the PSA across a wide range of temperatures, such that separate adhesives for low temperatures and high temperatures are no longer required.

### FIELD OF THE INVENTION

The invention relates to the field of pressure-sensitive adhesives, and more particularly to pressure-sensitive adhesives that are effective and applicable across a wide range of temperature.

### BACKGROUND OF THE INVENTION

Pressure-sensitive adhesives (PSAs) are typically applicable only in a particular temperature range. Adhesives often have an operating window between the Dahlquist temperature or glass transition temperature versus a softening point temperature. Temperatures near or below the glass transition temperature can result in adhesives having little to no tackiness and not functioning correctly, providing no tack, poor wet-in, and/or “slip and stick” failure modes. Temperatures near or above the softening point temperature can result in adhesive flow or debonding at low levels of applied stress.

To formulate adhesives for low temperature settings (e.g., freezing temperatures), the conventional method is to reduce tackifying resin content or to increase the amount of plasticizer. However, this method often sacrifices high temperature performance. On the other hand, compositions that minimize plasticizing products can possess high melt viscosities that are difficult to process due to manufacturing limitations in moving such high-viscous fluids. In order to overcome equipment limitations, the processing temperature could be increased to reduce viscosity; however, for coating on substrates, such as polyethylene, polyethylene terephthalate, polypropylene, and high density polyethylene, these excessively high temperatures can be unfavorable due to being above the heat deflection temperatures of the substrates. High temperatures can also cause excessive oxidation and reduce adhesive performance.

The above-mentioned drawbacks and difficulties are common to conventional hot-melt PSAs. Accordingly, what is needed is a PSA composition that is operable across a wide range of temperatures. However, in view of the art considered as a whole at the time the present invention was made, it was not obvious to those of ordinary skill in the field of this invention how the shortcomings of the prior art could be overcome.

While certain aspects of conventional technologies have been discussed to facilitate disclosure of the invention, Applicants in no way disclaim these technical aspects, and it is contemplated that the claimed invention may encompass one or more of the conventional technical aspects discussed herein.

The present invention may address one or more of the problems and deficiencies of the prior art discussed above. However, it is contemplated that the invention may prove useful in addressing other problems and deficiencies in a number of technical areas. Therefore, the claimed invention should not necessarily be construed as limited to addressing any of the particular problems or deficiencies discussed herein.

In this specification, where a document, act or item of knowledge is referred to or discussed, this reference or discussion is not an admission that the document, act or item of knowledge or any combination thereof was at the priority date, publicly available, known to the public, part of common general knowledge, or otherwise constitutes prior art under the applicable statutory provisions; or is known to be relevant to an attempt to solve any problem with which this specification is concerned.

### SUMMARY OF THE INVENTION

The long-standing but heretofore unfulfilled need for wide-temperature PSA compositions is now met by a new, useful, and nonobvious invention.

An exemplary embodiment of the current invention includes a pressure-sensitive adhesive composition and uses thereof, where the composition comprises a styrenic block copolymer having low diblock content, an aliphatic tackifier, an aromatic tackifier, and an oil-based plasticizer. These components results in a composition having a phase-separated morphology with at least two distinct domains, in turn resulting in a wide operable temperature window, e.g., between about 5-140° F. or more preferably between about 25-120° F.

An exemplary embodiment of the current invention includes a pressure-sensitive adhesive composition and uses thereof, where the composition comprises a styrenic block copolymer, at least one tackifier, and a plasticizer, where the composition has the following properties: (1) a constant load debonding rate between about 0.001 in/min and about 0.03 in/min at 120° F.; and (2) a peel adhesion (e.g., T-peel adhesion, bond-to-concrete peel adhesion) between about 3 lbs/in and about 25 lbs/in at 25° F.

Alternative embodiments of the current invention include pressure-sensitive adhesive compositions that are formed of a unique blend of components, resulting in a unique set of properties. Any combination of such components and properties are contemplated herein as within the scope of the current invention.

These and other important objects, advantages, and features of the invention will become clear as this disclosure proceeds.

The invention accordingly comprises the features of construction, combination of elements, and arrangement of parts that will be exemplified in the disclosure set forth hereinafter and the scope of the invention will be indicated in the claims.

### DETAILED DESCRIPTION OF EXEMPLARY EMBODIMENTS

In the following detailed description of the preferred embodiments, reference is made to the accompanying drawings, which form a part thereof, and within which are shown by way of illustration specific embodiments by which the invention may be practiced. It is to be understood that other embodiments may be utilized, and structural changes may be made without departing from the scope of the invention.

As used in this specification and the appended claims, the singular forms “a”, “an”, and “the” include plural referents unless the content clearly dictates otherwise. As used in this specification and the appended claims, the term “or” is generally employed in its sense including “and/or” unless the context clearly dictates otherwise.

As used herein, “about” means approximately or nearly and in the context of a numerical value or range set forth means ±15% of the numerical. In exemplary embodiments, the term “about” can include traditional rounding according to significant figures of the numerical value. In addition, the phrase “about ‘x’ to ‘y’” includes “about ‘x’ to about ‘y’”.

Further, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited. For example, whenever a numerical range with a lower limit, RL, and an upper limit RU, is disclosed, any number R falling within the range is specifically disclosed. In particular, the following numbers R within the range are specifically disclosed: R=RL+k(RU−RL), where k is a variable ranging from 1% to 100% with a 1% increment, e.g., k is 1%, 2%, 3%, 4%, 5% . . . 50%, 51%, 52% . . . 95%, 96%, 97%, 98%, 99%, or 100%. Moreover, any numerical range represented by any two values of R, as calculated above, is also specifically disclosed.

In a first example embodiment, the current invention is a hot-melt pressure-sensitive adhesive composition, comprising a styrenic block copolymer having a diblock content between about 5% and about 40% by weight of the styrenic block copolymer, an aliphatic tackifier that associates with a mid-block of the styrenic block copolymer, an aromatic tackifier that associates with an end-block of the styrenic block copolymer and is immiscible within the remainder of the adhesive composition, and an oil-based plasticizer. The hot-melt pressure-sensitive adhesive composition has (1) a phase-separated morphology, such that the composition comprises at least two distinct domains and (2) an operable temperature window between about 5° F. and about 140° F.

In a second example embodiment, which may be based on the first example embodiment above, the aromatic tackifier is a C9 tackifier.

In a third example embodiment, which may be based on any of the first through second example embodiments above, the aromatic tackifier is an alpha methyl styrene tackifier.

In a fourth example embodiment, which may be based on any of the first through third example embodiments above, the aliphatic tackifier is a C5 tackifier.

In a fifth example embodiment, which may be based on any of the first through fourth example embodiments above, the aliphatic tackifier is absent a miscibility-effecting amount of aromatic modifications.

In a sixth example embodiment, which may be based on any of the first through fifth example embodiments above, the styrenic block copolymer is a styrene-isoprene-styrene block copolymer. In an aspect of this sixth example embodiment, the styrene-isoprene-styrene block copolymer has a melt flow index of about 8-28, a styrene content of about 10-30%, and a diblock percentage at or below about 38% by weight of the styrene-isoprene-styrene block copolymer. In a further or alternative embodiment, which may be based on any of the first through sixth example embodiments, the styrenic block copolymer can have a diblock content between about 15% and about 38% by weight of the styrenic block copolymer.

In a seventh example embodiment, which may be based on any of the first through sixth example embodiments above, the operable temperature window is about 25-120° F.

In an eighth example embodiment, which may be based on any of the first through seventh example embodiments above, the oil-based plasticizer is an aliphatic plasticizer chosen from paraffinic oils, naphthenic oils, mineral oils, and a combination thereof.

In a ninth example embodiment, which may be based on any of the first through eighth example embodiments above, the styrenic block copolymer is about 10-50% by weight of the composition, the aromatic tackifier is between about 1% and about 15% by weight of the composition, the aliphatic tackifier is between about 35% and about 55% by weight of the composition, and the oil-based plasticizer is between about 15% and about 25% by weight of the composition.

In a tenth example embodiment, which may be based on any of the first through ninth example embodiments above, the aromatic tackifier has a softening point that is higher than a softening point of the aliphatic tackifier. In an aspect of this tenth example embodiment, the aliphatic tackifier has a softening point of about 10-120° C., and the aromatic tackifier has a softening point of about 50-250° C.

In an eleventh example embodiment, which may be based on any of the first through tenth example embodiments above, the adhesive composition further comprises an antioxidant and a stabilizer in an amount of about 0.1%-2% by weight of the composition.

In a twelfth example embodiment, which may be based on any of the first through eleventh example embodiments above, the adhesive composition has the following properties: (1) a constant load debonding rate between about 0.003 in/min and about 0.03 in/min, acquired with a 180° peel orientation at 120° F. under a constant load of about 150 grams per inch of width; and (2) a peel adhesion between about 3 lbs/in and about 25 lbs/in at 25° F. In an aspect of this twelfth example embodiment, the peel adhesion comprises T-peel adhesion, acquired according to modified ASTM D1876 at a run rate of 2 inches/min, −15 minutes after an adhesive bond is formed, at 25° F. In an alternative or additional aspect of this twelfth example embodiment, the peel adhesion comprises bond to concrete peel adhesion, acquired according to modified ASTM D903, with an average peel angle of 90°, at 25° F., In yet another alternative or additional aspect of this twelfth example embodiment, the adhesive composition has an average melt viscosity of about 2000-5000 cP at 350° F. and/or an average melt viscosity of about 6000-15000 cP at 300° F., acquired at a temperature between 250-400° F. on a parallel plate rheometer operating in steady state flow mode from shear rates of 0.1-100 l/s.

In a thirteenth example embodiment, the current invention is a hot-melt pressure-sensitive adhesive composition, comprising a styrenic block copolymer, at least one tackifier, and a plasticizer, wherein the pressure-sensitive adhesive composition has the following properties: (1) a constant load debonding rate between about 0.003 in/min and about 0.03 in/min, acquired with a 180° peel orientation at 120° F. under a constant load of about 150 grams per inch of width; and (2) a peel adhesion between about 3 lbs/in and about 25 lbs/in at 25° F.

In a fourteenth example embodiment, which may be based on the thirteenth example embodiment above, the styrenic block copolymer has a diblock content between about 15% and about 38% by weight of the styrenic block copolymer.

In a fifteenth example embodiment, which may be based on any of the thirteenth through fourteenth example embodiments above, the peel adhesion comprises T-peel adhesion, acquired according to modified ASTM D1876 at a run rate of 2 inches/min, −15 minutes after an adhesive bond is formed, at 25° F.

In a sixteenth example embodiment, which may be based on any of the thirteenth through fifteenth example embodiments above, the peel adhesion comprises bond to concrete peel adhesion, acquired according to modified ASTM D903, with an average peel angle of 90°, at 25° F.

In a seventeenth example embodiment, which may be based on any of the thirteenth through sixteenth example embodiments above, the adhesive composition has a melt viscosity of about 2000-5000 cP at 350° F. and/or a melt viscosity of about 6000-15000 cP at 300° F., F and/or an average melt viscosity of about 6000-15000 cP at 300° F., acquired at a temperature between 250-400° F. on a parallel plate rheometer operating in steady state flow mode from shear rates of 0.1-100 l/s.

In an eighteenth example embodiment, the current invention is a waterproofing product comprising the hot-melt pressure-sensitive adhesive composition based on any of the first through twelfth example embodiments above.

In a nineteenth example embodiment, the current invention is a waterproofing product comprising the hot-melt pressure-sensitive adhesive composition based on any of the thirteenth through seventeenth example embodiments above.

In a twentieth example embodiment, the current invention is a hot-melt pressure-sensitive adhesive composition, use thereof, building material, and/or waterproofing product based on any one or more—or even all—of the first through nineteenth example embodiments above.

In certain embodiments, the current invention is a PSA composition that is operable across a wide range of temperatures, for example 25-120° F. for a total operating range of 95° F. The composition comprises a thermoplastic elastomer having a diblock content, an aliphatic tackifier resin, an aromatic tackifier resin, and a plasticizer. The combination of components results in a PSA having a relatively low diblock rubber content (e.g., approximately <38% by weight of the rubber), in turn leading to phase separation where specific domains of the adhesive do not mix with other domains. This phase separation allows for the PSA to be operable across the wide range of temperatures.

It is contemplated that the PSA composition discussed herein may contain various thermoplastic elastomers. Suitable non-bituminous, or synthetic, PSAs include butyl rubber based adhesives, polyisobutylene based adhesives, butyl based adhesives, styrene-isoprene-styrene (SIS) based adhesives, styrene-ethylene-butylene-styrene (SEBS) based adhesives, styrene-butadiene-styrene (SBS) based adhesives, styrene-butadiene rubber (SBR) based adhesives, and combinations thereof. Preferably, the synthetic adhesive is a pressure sensitive hot melt adhesive block copolymer of SIS, SBS or SEBS, most preferably SIS block copolymer. For a more detailed description of PSAs, see Satas, Handbook Of Pressure Sensitive Adhesive Technology, by Van Nostrand Reinhold Company, Inc. (1982), incorporated herein by reference. Other rubbers include polyisoprene, polybutadiene, natural rubber, polychloroprene rubber, ethylene-propylene rubber, ethylene alpha olefin, nitrile rubbers, and acrylic rubber. In certain embodiments, the rubber content is about 10%-50% by weight of the composition, preferably about 20%-40% by weight of the composition.

The non-bituminous or synthetic PSA can optionally contain typical additives, such as light absorbers (e.g., carbon black, benzotriazoles, etc.), light stabilizers (e.g., hindered amines, benzophenones), antioxidants (e.g, hindered phenols), fillers (e.g., calcium carbonate, silica, titanium dioxide, etc.), plasticizers, rheological additives, and mixtures thereof. Preferred synthetic adhesives contain light absorbers, light stabilizers, and antioxidants.

A synthetic PSA may also contain a plasticizer or oil. Suitable oils include, but are not limited to, aromatic oil, naphthenic oil, paraffinic oil, mineral oil, natural oil, and combinations thereof. Aromatic, naphthenic, and paraffinic oils are used in preferred embodiments. Suitable plasticizers may be low molecular weight tackifiers that are viscous liquids at about 75° F. In certain embodiments, synthetic PSAs contain about 5-25% of a plasticizer or oil with preferred embodiments containing 10-20% plasticizer or oil. The PSA may also comprise an inorganic filler such as silica, calcium carbonate, talc, or clay. If present, the weight percentage of the filler may be about 0% to 50% of the total.

In an embodiment, the rubber is a styrene-b-isoprene-b-styrene (SIS) triblock polymer with a melt flow index of about 10-30, a styrene content of about 10-30%, and a diblock percentage between about 5-38%. In certain embodiments, two or more SIS rubbers may be used, provided they meet the melt flow index, styrene content, and diblock percentage listed above.

In certain exemplary embodiments, the present invention teaches a PSA composition that comprises one or more SIS rubbers with specific styrene and isoprene content to provide for a low diblock content, at least two tackifier resins wherein one tackifier resin is aliphatic in nature (e.g., C5 resins) and the other is aromatic in nature (e.g., C9 resins), and at least one aliphatic oil-based plasticizer. Keeping the diblock copolymer content at or below a specific threshold (e.g., −40%) in the synthetic rubber, in combination with the tackifier resins (specifically the aromatic tackifier), results in a phase separated morphology wherein specific domains of the adhesive do not mix with other domains. Phase separation maintains high-temperature creep resistance (resistance to flow at high temperatures), in turn reducing melt viscosity of the entire composition, while also preserving good low temperature adhesion values. More specifically, phase separation keeps viscosity of the PSA within a preferred range and maintains the high softening point of the aromatic tackifier, which leads to high-temperature resistance. When these compositions have too much diblock from the SIS rubber, the phase separation may not occur due to the diblock facilitating miscibility of the phases, which results in increased solubility of the aromatic tackifier in the PSA. This, in turn, leads to lower temperature resistance, which is unfavorable due to limits on outdoor applications, particularly in hot climates, and higher viscosities, which can be difficult to manufacture.

Within the context of the present disclosure, the term “diblock content” refers to an amount by weight of copolymer that has two distinct homopolymer subunits bonded together, as opposed to a copolymer that has three distinct blocks (triblock). For example, an SIS block copolymer contains a mixture of both triblock content (polystyrene end-block, polyisoprene mid-block, polystyrene end-block) and diblock content (polystyrene block, polyisoprene block). It is noted that a more general styrenic block copolymer is similar in that it contains polystyrenic blocks, though the polyisoprene block can alternatively be based on butadiene (SBS), ethylene-butylene (SEBS), etc., as indicated above. The PSA taught by the present disclosure includes a low diblock content, preferably about 40% or less, about 38% or less, about 36% or less, about 34% or less, about 32% or less, about 30% or less, about 28% or less, about 26% or less, about 24% or less, about 22% or less, about 20% or less, about 15% or less or in a range between any two of these values. All percentages are by weight of the rubber, unless otherwise stated. If two or more rubbers are used, the diblock content is calculated as a weighted average of both rubbers. A diblock content above ˜40% results in unwanted homogeneity of the domains in the PSA, where phase separation is desired. A minimum diblock content is about 5%; an even lower diblock content might result in diminished applicability and/or performance of the PSA. Preferably, the diblock content in the PSA compositions disclosed herein is between about 15% and about 38% by weight of the copolymer.

In certain embodiments, the amount of styrenic diblock copolymer within the composition can be between about 10% and about 50% by weight of the composition, more preferably between about 15% and 40% by weight of the compoistion, and even more preferably between about 20% and about 30% by weight of the composition

Within the context of the present disclosure, the term “plasticizer” refers to materials that can be added to the composition to soften the adhesive, increase viscosity, improve dispersion of fillers or other additives, and/or aid in breakdown of the elastomer. Examples of plasticizers that are contemplated to be used herein include, but are not limited to, aliphatic oil-based plasticizers, such as paraffinic oils, naphthenic oils, mineral oils, natural oils, and combinations thereof. Other suitable oils are also contemplated herein, as long as the oil does not have a freezing point above about −25° C. and associates well with the aliphatic tackifier and block copolymer. In a preferred embodiment, one or more naphthenic oils are used as the plasticizer. The amount of plasticizer within the adhesive can be between about 10% and about 40% by weight of the composition, more preferably between about 15% and 30% by weight of the compoistion, and even more preferably between about 18% and about 25% by weight of the composition.

Within the context of the present disclosure, the term “tackifier resin” refers to materials added to an adhesive to improve the tack and peel adhesion along the surface of the adhesive. As taught herein, certain embodiments of the current invention disclose inclusion of at least one aromatic tackifier resin and at least one aliphatic tackifier resin. Examples of aromatic C8 or C9 tackifiers include polymers made from monomers comprising styrene, methyl styrene, alpha methyl styrene, vinyl toluene, dicyclopentadiene, indene, methyl indene, and mixtures thereof. Examples of trade names for aromatic tackifiers include PICCO, PLASTOYN, PICCOTEX, KRISTALEX, ENDEX, REGALITE, REGALREZ TECKREZ C9, SUNTACK, and CLEARTACK. The aromatic tackifier should have good chemical affinity with the styrenic end-block of the rubber and should preferably be phase separated from the mixture of rubber, the aliphatic hydrocarbon tackifier, and the plasticizer. Further, the aromatic content of the aromatic tackifier should be greater than about 95% by weight. The amount of aromatic tackifier within the adhesive can be between about 0.1% and about 25% by weight of the composition, preferably between about 0.5% and about 20% by weight of the composition, and even more preferably between about 1% and about 15% by weight of the composition. In preferred embodiments, the aromatic tackifier is a polymer comprised of aromatic monomers such as styrene and alpha-methyl styrene. In certain embodiments, the aromatic tackifier has an average molecular weight between about 650-3000 g/mol and a softening point between about 120-160° C.

As mentioned, in addition to an aromatic tackifier, an aliphatic tackifier is also included in the PSA composition. Examples of aliphatic tackifiers include, but are not limited to, rosin esters, hydrogenated rosin esters, C5 hydrocarbon resins, terpene resins, and hydrogenated C9 tackifiers. The aliphatic tackifier should have good chemical affinity with the mid-block (e.g., isoprene block of an SIS copolymer, butadiene block of an SBS copolymer, ethylene-butadiene block of a SEBS copolymer) of the rubber, such that when mixed with the rubber and plasticizer, an optically clear composition is yielded. Aliphatic tackifiers may be sold under trade names such as PICCOTAC, ESCOREZ, WINGTACK, TECHREZ C5, SYLVATAC, SYLVARES, SYLVALITE, FORAL, and ALTATAC. Further, the aliphatic tackifier should be polymeric or oligomeric in nature and should not have aromatic modifications. Without being bound by theory, aliphatic tackifiers with aromatic modification are not preferred, as the aromatic modification can cause an increase in miscibility of the adhesive system by providing better compatibility between the aromatic and aliphatic regions. The amount of aliphatic tackifier within the adhesive can be between about 25% and about 75% by weight of the composition, preferably between about 30% and about 65% by weight of the composition, and even more preferably between about 35% and about 55% by weight of the composition. In certain embodiments, the aliphatic tackifier has an average molecular weight between about 300-4000 g/mol and a softening point between about 50-120° C.

Within the context of the present disclosure, the term “softening point” refers to the temperature at which a material would further soften to enable a ball to pass through a ring in a vial of the material being measured. Unless otherwise specified, the softening point can be determined by ASTM E 28 or an equivalent method. As discussed herein, the softening points of the aromatic tackifier and the aliphatic tackifier are relevant, in that their relation to each other facilitates the adhesive's operation within a wide temperature window (e.g., 25-120° F.). Regardless of the aliphatic tackifier's specified softening point, it is desirable for the softening point of the aromatic tackifier (i.e., the resin that associates with the styrenic end-blocks of the rubber) to be higher than the softening point of the aliphatic tackifier (i.e., the resin that associates with the aliphatic portion of the rubber). Without being bound by theory, it is believed that the higher softening point of the aromatic tackifier—when compared to the aliphatic tackifier—enables the PSA composition to have both high temperature bonding ability while simultaneously maintaining tack and adhesion at low temperatures. It is further believed that this phenomenon is primarily driven through the aromatic tackifier having phase separation from the rubber, the aliphatic tackifier, and the plasticizer, enabling the aromatic tackifier to maintain its high softening point and provide creep resistance at high temperature. Preferably, the aliphatic tackifier has a softening point of about 10-120° C., more preferably about 20-110° C., and even more preferably about 30-105° C. Preferably, the aromatic tackifier has a softening point of about 50-250° C., more preferably about 65-225° C., and even more preferably about 80-200° C.

Within the context of the present disclosure, the term “phase separation” refers to distinct chemical domains or layers within a material, where the distinction is based on differences in chemical composition or structure. At the interface between the domains, phase separation should be observable to the naked eye or via optical microscope. Phase separation can be observed, for example, when domains are greater than or equal to about 400 μm in thickness and/or when the domains appear opaque and not clear as in a homogenous blend. Phase separation of a PSA as taught herein is achieved by combinations of components that result in a low diblock content (e.g., less than or equal to about 40% by weight of the rubber). When diblock content is insufficiently low (i.e., too high), phase separation can be lost, as the diblock can function as a phase miscibilizer, resulting in high viscosities, which are difficult to manufacture, and loss of the high softening point of the aromatic tackifier due to becoming a miscible polymer blend. Phase separation also facilitates the operation of the current PSA in a wide range of temperatures due to maintaining the thermal properties of each phase domain, resulting from one domain being rich in aromatic tackifier and the other domain being rich in aliphatic tackifier.

Within the context of the present disclosure, the term “melt viscosity” refers to the rate of a thermoplastic material's flow or extrusion through an opening at a specific load and temperature. A higher viscosity liquid takes longer to go through the opening than a lower viscosity liquid. Viscosity is typically recorded as units of centipoise (cP), which is directly related to the time spent for the load of thermoplastic material to flow through the opening. One centipoise is equivalent to one milli-Pascal-second. Within the context of the present disclosure, melt viscosity measurements are acquired at a specified temperature typically between 250-400° F. on a 25-mm diameter stainless steel parallel plate rheometer operating in steady state flow mode from shear rates of 0.1-100 l/s. The reported viscosity is the average of the Newtonian viscosity range. The Newtonian range is defined as when the viscosity is independent of shear rate, i.e., <0.4 Pa·s variance.

Preferably, the PSA taught by the present disclosure has a melt viscosity (at 350° C.) of about 20000 cP or lower, about 15000 cP or lower, about 7000 cP or lower, about 6000 cP or lower, about 4000 cP or lower, about 3000 cP or lower, about 2000 cP or lower, about 1000 cP or lower, or in a range between any two of these values. More preferably, the melt viscosity of the PSA composition is between about 2000 cP and about 5000 cP at 350° F. Furthermore, the PSA taught by the present disclosure has a melt viscosity (at 300° C.) of about 100000 cP or lower, about 80000 cP or lower, about 50000 cP or lower, about 30000 cP or lower, about 20000 cP or lower, about 10000 cP or lower, about 8000 cP or lower, about 5000 cP or lower, or in a range between any two of these values. More preferably, the melt viscosity of the PSA composition is between about 6000 cP and about 15000 cP at 300° F.

In certain embodiments, the current invention is a hot melt pressure sensitive styrenic rubber adhesive with a phase separated morphology that functions within an operable temperature window of ˜25-120° F. (or otherwise a total operating range of about 95° F.). The PSA comprises (1) a synthetic rubber triblock copolymer (e.g., SIS, SBS, etc.) with a diblock percentage of less than or equal to about 40%; (2) a first tackifier that associates with the aliphatic portion of the rubber (e.g., isoprene, butadiene, etc.); (3) a plasticizer; and (4) a second tackifier having poor solubility in the remainder of the PSA and being aromatic in nature, preferably synthesized from alpha methyl styrene or styrene.

Within the context of the present disclosure, the term “operable temperature window” refers to a range of temperatures within which the PSA disclosed herein functions effectively, in that the adhesive can be installed within the temperature range and perform the desired task as needed based on the properties discussed herein. Operable is defined as being able to bond to other pressure sensitive adhesives (e.g., SIS-based PSA) across a wide temperature range and/or maintain a bond to a variety of substrates (e.g., plastics, PSAs, concrete, and other polymeric substrates) across a wide temperature range, where the bond to specific substrates often has a minimum bonding value obtained from a peel adhesion test. This wide temperature range is tunable, such that it can be, e.g., about 15-125° F., about 25-120° F., about 30-130° F., and/or about 10-110° F. This temperature range will become clearer as this specification continues. The term “operable” also encompasses the SIS adhesive incorporated into a product, such as a plastic carrier sheet. As discussed, an objective of the current PSA is operability across a wide range of temperatures, rather than needing one adhesive for low-temperature applications and another adhesive for high-temperature applications, for example. Operability of the adhesive is further defined by the user or applicator of the adhesive. For example, operability of the current adhesive can be in waterproofing of construction products, and thus there often are needs to bond to specific substrates, such as polyolefins, polyesters, polyurethanes, acrylics, alkyds, other plastics, concrete, concrete masonry units, mortar, cement board, gypsum board, wood, engineered wood, steel, aluminum, and glass. In preferred embodiments, the current PSA can be used or implemented in any building materials where a wide operable temperature range could be desired (e.g., regions with temperature fluctuations, elimination of multiple PSA types, etc.), for example including, but not limited to, pre-applied waterproofing membranes, post-applied waterproofing membranes, tapes, flooring materials, and roofing materials.

Waterproofing can be defined as methods to block water and/or water vapor from entering into a building. Waterproofing methodology is varied, but can be broadly defined as creating a continuous barrier with a plastic or polymeric membrane that encloses the building, which is broadly known as the building envelope, or otherwise provides a barrier for water entry along at least a portion of the building. There are a variety of waterproofing membrane technologies. In certain embodiments, the current invention is contemplated to be used in self-adhered waterproofing membranes, where a pressure sensitive adhesive is used to attach the waterproofing system to the building's structure. The building's structure can be defined as the foundation, the walls, the roof, or other parts of the exterior portion of the building where waterproofing is desired, but there are also instances where interior portions of the building may require waterproofing, such as rooms having water access points (e.g., bathrooms, kitchens, or appliance rooms that contain appliances using water).

Membrane waterproofing technologies typically cover two different types of applications: pre-applied and post-applied. Pre-applied waterproofing applications typically occur prior to volumetric construction of the building and post-applied waterproofing typically implies that the waterproofing layer is being installed onto a partially finished structure at the job site. Pre-applied waterproofing may encompass below and above grade applications. Pre-applied waterproofing in below grade applications can be applied to soil retention systems prior to laying of rebar and/or concrete formworks. Pre-applied waterproofing in below grade applications may also encompass pre-cast concrete structures that are then joined together on the job site. Pre-applied waterproofing membranes in above grade structures may be applied in a manufacturing process prior to construction of the building such as a manufactured wall assembly or volumetric modular structure is assembled at the job site and the waterproofing membrane is joined together at the site. Post-applied waterproofing in below grade applications will typically be applied to the exterior of semi-finished or finished foundation walls and can potentially tie-in to a pre-applied waterproofing membrane beneath a horizontal slab. Post-applied below grade waterproofing may also be typically applied prior to erection of a drainage mat or protective layer before backfill with stone aggregate and soil. Post-applied waterproofing in above grade applications will typically be applied to building sheathing on a volumetrically finished or semi-finished structures and can also be applied to pitched roofs. Post-applied waterproofing is typically applied prior to affixing the final building cladding or roofing material. In both pre-applied and post-applied waterproofing membrane applications adhesives are useful in that they keep the membrane affixed to the intended structure that needs waterproofing and installation of this membrane may be done at a job site with exposure to weather events.

Pressure sensitive adhesives can provide benefits to waterproofing structures such as providing nail sealing of fasteners to materials that have to be mechanically fastened to the building structure. Pressure sensitive adhesives can also mitigate lateral water migration in the event of a breach in the finished or semi-finished building envelope, which can mitigate water damage and keep defects contained to a specific area. Pressure sensitive adhesives, however, typically function primarily on a rheological mechanism, which can be influenced by temperature. Being able to install adhesive-based waterproofing membranes across a wider temperature range, or within a specific temperature window, experienced at job sites can provide a significant advantage to keeping building schedules on time and in budget. Additionally, from a manufacturing and product management perspective, having one adhesive that can function across the range of two adhesives is advantageous due product simplification and less chances of adhesive cross contamination during manufacturing when adhesive types are switched.

Referring back to operable temperature window, this parameter is typically recorded in degrees Fahrenheit. Within the context of the present disclosure, operable temperature window is acquired by conducting three types of tests at different temperatures: adhesive-adhesive peel adhesion, bond-to-concrete peel adhesion, and constant load debonding rate (indicative of creep). In the context of the current disclosure, a PSA can be considered “operable” across a temperature window if it meets at least one of these tests/properties at an upper testing temperature (e.g., 120° F.) and at least one of these tests/properties at a lower testing temperature (e.g., 25° F.). This will become clearer as this specification continues. Preferably, the PSA has an operable temperature window between about 5° F. and about 140° F. (total operating range of about 120° F.), more preferably between about 15° F. and about 130° F. (total operating range of about 115° F.), even more preferably between about 25° F. and about 120° F. (“total operating range” of about 95° F.), or in a range between any two of these values.

Within the context of the present disclosure, the term “peel adhesion” refers to a measure of bond strength between two distinct materials, such as between a waterproofing membrane and concrete or between two of the same or different PSAs, where the current PSA resists static forces that cause one or both materials to de-bond. Peel adhesion is typically recorded as an average force per linear width, e.g., as measured in inches (pounds per linear inch, lbs/in or PLI) or Newtons per millimeter (N/mm), and may be determined by methods known in the art. Within the context of the present disclosure, peel adhesion measurements of the current PSA to other PSAs will be referred to as a T-Peel test and is acquired according to a modified ASTM D1876 at a run rate of 2 inches/min, ˜15 minutes after the adhesive bond is formed, at either 25° F. or 75° F., unless otherwise stated. Preferably, the PSA taught by the present disclosure has a T-Peel adhesion (at ˜75° F.) between about 1 lbs/in and about 30 lbs/in, more preferably between about 3 lbs/in and about 25 lbs/in, or even more preferably between about 5 lbs/in and about 15 lbs/in. Furthermore, the PSA taught by the present disclosure is contemplated to have a T-Peel adhesion (at ˜25° F.) between about 3 lbs/in and about 30 lbs/in, preferably between about 5 lbs/in and about 30 lbs/in, more preferably between about 8 lbs/in and about 30 lbs/in, or even more preferably between about 10 lbs/in and about 30 lbs/in. Furthermore, the PSA taught by the present disclosure has a T-Peel adhesion (at −15° F.) between about 8 lbs/in and about 30 lbs/in, more preferably between about 10 lbs/in and about 30 lbs/in, or even more preferably between about 12 lbs/in and about 30 lbs/in.

Within the context of the present disclosure, bond to concrete peel adhesion and bond to concrete-bonding layer peel adhesion (collectively “BTC peel adhesion) are measured by a peel test of a waterproofing membrane comprising certain embodiments of the current PSA adhered to concrete according to a modified ASTM D903, at a run rate of 2 inches/minute with an average peel angle of 90°. The peel test can be conducted over a variety of temperatures (e.g., 25-120° F.) or after a variety of exposure testing, such as water immersion or temperature cycling. The waterproofing membrane could also be subjected to a variety of environmental conditions, such as outdoor exposure at various angles, concentrated ultraviolet light exposure, high humidity, or a combination of conditions, prior to bonding to concrete or concrete-bonding layer. Bond to concrete is more relevant in post-applied applications, and bond to concrete-bonding layers is more relevant in pre-applied applications. Examples of concrete-bonding layers include, but are not limited to, non-hydrated cementitious materials, acrylic coatings, woven geotextiles, and non-woven geotextiles. BTC peel adhesion is typically measured in pounds of force per linear inch of adhered waterproofing membrane, or lbs/in. Preferably, the PSA taught by the present disclosure has a BTC peel adhesion (at both 25° F. and 75° F.) between about 3 and about 50 lbs/in, more preferably between about 4 and about 40 lbs/in, or even more preferably between about 5 and about 30 lbs/in.

Within the context of the present disclosure, the high temperature “creep” of the adhesive refers to the ability of the material to deform under constant load over a period of time. Creep can be measured by performing a constant load test at various temperatures in the operable temperature window. A constant load test at 120° F. performed with a 180° peel geometry is a way to understand the maximum potential of creep across the entire operating temperature range because higher temperatures typically induce more creep. The adhesive's ability to resist debonding from concrete is important when waterproofing membranes are exposed to the environment and have additional membranes attached that may be free-hanging until the rest of the structure can be put in place. Creep of the adhesive in the constant load test is called the constant load debonding rate and is recorded as a rate of inches/minute, where the constant load used herein is about 150 grams per inches of width. Specifically, the test used to measure the constant load debonding rate of the PSA involves bonding the waterproofing membrane assembly (including the PSA) directly to smooth concrete (i.e., typical of a post-applied application), exposing the assembly to a temperature of about 120° F., allowing the assembly to equilibrate to 120° F. for at least 5 hours, and hanging the weight from one end of the membrane assembly. The distance of debonding is measured every ˜15 minutes. The membrane assembly (including the PSA) is about 1-4 inches in width and about 6-10 inches in length, with at least two inches of non-bonded area to affix the constant load weight. Preferably, the PSA taught by the present disclosure has a constant load debonding rate between about 0.001 in/min and about 0.03 in/min, more preferably between about 0.002 in/min and about 0.02 in/min, or even more preferably between about 0.003 in/min and about 0.02 in/min. For post-applied applications, the constant load test may be performed with a waterproofing membrane assembly, where the concrete is primed with a suitable primer. For pre-applied applications, the constant load test may be performed with a waterproofing membrane assembly, where the assembly further includes a concrete bonding layer.

It is contemplated herein that a waterproofing membrane can be any sheet of material that is designed to prevent the passing of water or water vapor therethrough. For example, a waterproofing membrane can vary in width and length, about 40-80 mils in thickness (1 mil=0.001 inches). Typically the waterproofing membrane comprises a plastic membrane, wherein the plastic can be composed of polyethylene, polyethylene terephthalate, ethylene vinyl alcohol, ethylene vinyl acetate, crosslinked polyethylene, polypropylene, crosslinked polypropylene, polyurethane, acrylic, and mixtures thereof. Mixtures can be laminations of the above polymers or polymer blends and can be between about 10-60 mils in thickness. The waterproofing membrane can also have a PSA component between about 15-30 mils in thickness; certain embodiments of the current PSA are used in the manner described here. The waterproofing membrane may also have an optional concrete bonding layer that facilitates the bonding of the PSA and waterproofing membrane to concrete as it cures. If present, the concrete bonding layer can be between about 1-5 mils in thickness. Optionally, the waterproofing membrane can include additional layers on the PSA, such as release liners, between about 1-5 mils in thickness or other layers as needed.

Within the context of the present disclosure, the term “cure” refers to the amount of time needed for concrete to reach a desired compression strength (≥˜3 kpsi). BTC peel adhesion of the PSA is only measured once concrete has reached sufficient “cure.” The waterproofing assemblies, where certain embodiments of the current PSA are typically used, involve bonding to concrete while the concrete is curing. It is contemplated herein that for embodiments of the current PSA where a bond to concrete is desired, the concrete mix designs are kept constant, and after about 7 days of curing at 75° F., the concrete reaches the desired compressive strength. For simulation of cold weather, a low-temperature BTC test is performed where concrete accelerators are used in the concrete mix design to speed up curing at 50° F. Concrete is kept at 50° F. until it reaches 3 kpsi and then is moved to the lower temperature of 25° F. for the BTC peel adhesion measurements to be conducted. Additional details of low temperature concrete curing, acceptable accelerators, and definitions of cold weather can be found in ACI 306R-88.

Furthermore, additives may be added at certain points during the foregoing formulating process of the PSA. Within the context of the present disclosure, the term “additive” refers to optional materials that can be added to the PSA composition. Additives can be added to alter or improve desirable properties in the PSA composition, or to counteract undesirable properties therein. Examples of additives includes, but are not limited to, fillers, inhibitors, pigments, anti-settlement aids, rheology modifiers, UV stabilizers, degassers, antistatic agents, accelerants, catalysts, antioxidants, stabilizers, fire retardants, pH adjusters, reinforcing agents, thickening or thinning agents, elastic compounds, chain transfer agents, radiation absorbing or reflecting compounds, and other additives known in the art. The amount of additive utilized can be about 0-50% by weight of the composition in which the additive is present. Preferably, the composition includes antioxidants and stabilizers in an amount of about 0.1%-2% by weight of the composition.

### EXAMPLES/EXPERIMENTS

While the invention is described herein using a limited number of embodiments, these specific embodiments are not intended to limit the scope of the invention as otherwise described and claimed herein. Modification and variations from the described embodiments exist. More specifically, the following examples are given as a specific illustration of embodiments of the claimed invention. It should be understood that the invention is not limited to the specific details set forth in the examples. All parts and percentages in the examples, as well as in the remainder of the specification, are by weight of the total PSA composition, unless otherwise specified.

### Comparative Example 1

A hot-melt PSA composition was formulated comprising an SIS block copolymer, an oil-based plasticizer, and an aliphatic tackifier, where the rubber content was about 30-35% by weight of the composition, the aliphatic tackifier was about 42-47% by weight of the composition, and the oil-based plasticizer was about 18-25% by weight of the composition. This composition had excellent low temperature performance but poor high temperature performance. Its operable temperature window was limited to about 25-60° F. (total operating range of about 35° F.). The operable temperature window can be modified based on amounts of the rubber, aliphatic tackifier, and oil-based plasticizer.

### Comparative Example 2

A hot-melt PSA composition was formulated comprising an SIS block copolymer, an oil-based plasticizer, and an aliphatic tackifier, where the rubber content was about 25-30% by weight of the composition, the aliphatic tackifier was about 53-58% by weight of the composition, and the oil-based plasticizer was about 12-17% by weight of the composition. This composition had excellent high temperature performance but poor low temperature performance. Its operable temperature window was limited to about 50-120° F. (total operating range of about 70° F.). The operable temperature window can be modified based on amounts of the rubber, aliphatic tackifier, and oil-based plasticizer.

### Comparative Example 3

A hot-melt PSA composition was formulated comprising an SIS block copolymer, an oil-based plasticizer, an aliphatic tackifier, and an aromatic tackifier, where the rubber content was about 30-35% by weight of the composition, the aliphatic tackifier was about 38-43% by weight of the composition, the oil-based plasticizer was about 20-25% by weight of the composition, and the aromatic tackifier was about 1-6% by weight of the composition. This composition had excellent low temperature performance but poor high temperature performance, including high viscosity in the temperature range of 275-350° F. The operable temperature window was limited to about 15-95° F. (total operating range of about 80° F.). The rubber had a diblock content of about 66%, and the composition appeared visually to be clear. The operable temperature window could be modified based on amounts of the rubber, aliphatic tackifier, and oil-based plasticizer. The loadings of the rubber, tackifiers, and oil are similar to Example 1 with the only difference being rubber diblock content.

### Example 1

A hot-melt PSA composition was formulated comprising an SIS block copolymer, an oil-based plasticizer, an aliphatic tackifier, and an aromatic tackifier, where the rubber content was about 30-35% by weight of the composition, the aliphatic tackifier was about 38-43% by weight of the composition, the oil-based plasticizer was about 20-25% by weight of the composition, and the aromatic tackifier was about 1-6% by weight of the composition. The addition of the aromatic tackifier that is not miscible with the hot-melt PSA was able to broaden the operable temperature window of the adhesive to about 15-120° F. for a total operating range of about 105° F. The operable temperature window can be modified by careful selection of aliphatic tackifier, rubber, and aromatic tackifier, wherein the aromatic tackifier possesses a softening point that is higher than the aliphatic tackifier, the diblock content of the rubber is about 5-30%, and the aromatic tackifier is separated into its own phase.

### Example 2

A hot-melt PSA composition was formulated comprising an SIS block copolymer, an oil-based plasticizer, an aliphatic tackifier, and an aromatic tackifier, where the rubber content was about 30-35% by weight of the composition, the aliphatic tackifier was about 35-40% by weight of the composition, the oil-based plasticizer was about 18-23% by weight of the composition, and the aromatic tackifier was about 8-12% by weight of the composition. The addition of the aromatic tackifier that is not miscible with the hot-melt PSA was able to broaden the operable temperature window of the adhesive to about 25-120° F. for a total operating range of about 95° F. The operable temperature window can be modified by careful selection of aliphatic tackifier, rubber, and aromatic tackifier, wherein the aromatic tackifier possesses a softening point that is higher than the aliphatic tackifier, the diblock content of the rubber is about 5-30%, and the aromatic tackifier is separated into its own phase.

TABLE 1
Formulations and properties of Comparative Example 1, Comparative
Example 2, Comparative Example 3, Example 1 (embodiment of the current
invention), and Example 2 (embodiment of the current invention).

| | Comp. Ex. 1 | Comp. Ex. 2 | Comp. Ex. 3 | Ex. 1 | Ex. 2 |
|---|---|---|---|---|---|
| SIS rubber | 30-35 | 25-30 | 30-35 | 30-35 | 30-35 |
| (%) | | | | | |
| Diblock | 38 | 38 | 66 | 23 | 32 |
| content (%) | | | | | |
| Aromatic | 0 | 0 | 1-6 | 1-6 | 8-12 |
| tackifier (%) | | | | | |
| Aliphatic | 42-47 | 53-58 | 38-43 | 38-43 | 35-40 |
| tackifier (%) | | | | | |
| Oil-based | 18-25 | 12-17 | 20-25 | 20-25 | 18-22 |
| plasticizer | | | | | |
| (%) | | | | | |
| Operable | 25-60 | 50-120 | 25-95 | 25-120 | 25-120 |
| temp. | | | | | |
| window (° F.) | | | | | |
| Total | 35 | 70 | 80 | 95 | 95 |
| operating | | | | | |
| range (° F.) | | | | | |
| T-Peel | 9 | 11 | 5.9 | 9 | 7.3 |
| Adhesion at | | | | | |
| 75° F. (lbs/in) | | | | | |
| T-Peel | 14 | 0 | 13.2 | 17 | 13.0 |
| Adhesion at | | | | | |
| 25° F. (lbs/in) | | | | | |
| T-Peel | 2 | 0 | — | 21 | — |
| Adhesion at | | | | | |
| 15° F. (lbs/in) | | | | | |
| Constant | 0.0428 | 0.0068 | 0.0484 | 0.014 | 0.0052 |
| load | | | | | |
| debonding | | | | | |
| rate at 120° | | | | | |
| F. (in/min) | | | | | |
| Bond to | 18 | 1.9 | 9.0 | 18 | 7.5 |
| Concrete at | | | | | |
| 25° F. (lbs/in) | | | | | |
| Bond to | 13 | 12 | 7.7 | 14 | 5.0 |
| Concrete at | | | | | |
| 75° F. (lbs/in) | | | | | |

When comparing the adhesive compositions from Examples 1-2 and Comparative Examples 1-3, the following observations can be made:
Comparative Example 1 generally discloses of a conventional low-temperature adhesive formulation. The adhesives of Examples 1-2 have better performance than the adhesive of Comparative Example 1 at 120° F. for the slow rate peel test.
Comparative Example 2 generally discloses of a conventional high-temperature adhesive formulation. The adhesives of Examples 1-2 have better performance than the adhesive of Comparative Example 2 at 25° F. for the BTC peel adhesion test and the T-peel adhesion test.
Comparative Example 3 includes an aromatic tackifier, which is absent in Comparative Examples 1 and 2, but shows the effect of the rubber having higher diblock content. The adhesive of Comparative Example 3 has similar performance to the adhesive of Comparative Example 1 in T-Peel adhesion, and BTC peel adhesion. However, Comparative Example 3 does have a higher constant load debonding rate than Examples 1-2 at 120° F., which limits its high temperature applications.
Example 2 has a higher diblock loading and higher aromatic tackifier loading than Example 1. This examples indicates how similar performance values can be obtained with different diblock content in the rubber and different loadings of aromatic tackifier, oil-based plasticizer, and aliphatic tackifier.

The data in Table 1 demonstrate that the adhesive compositions of Comparative Examples 1-3 performance relatively effectively at either a low temperature or a high temperature, but not both, whereas the adhesive compositions of Examples 1-2 perform effectively at both high temperature and low temperature.

TABLE 2
Viscosities of Comparative Example 1, Comparative Example 2,
Comparative Example 3, Example 1 (embodiment of the current invention), and
Example 2 (embodiment of the current invention) at 350° F. and 300° F. exposure
temperatures.

| | | | Comp. Ex | | |
|---|---|---|---|---|---|
| | Comp. Ex 1 | Comp. Ex 2 | 3 | Ex. 1 | Ex. 2 |
| Viscosity | 5777 ± 100 | 3025 ± 20 | 6191 ± 10 | 4023 ± 15 | 2446 ± 390 |
| (cP) at 350° | | | | | |
| F. coating | | | | | |
| temp. | | | | | |
| Viscosity | 16208 ± 63 | 9274 ± 70 | 97420 ± 100 | 11851 ± 202 | 5641 ± 307 |
| (cP) at 300° | | | | | |
| F. | | | | | |
| processing | | | | | |
| temp. | | | | | |

Table 2 demonstrates that the adhesive of Example 1 has a similar or lower viscosity at 350° F. and 300° F. when compared to the adhesives of Comparative Examples 1-3 and specifically a significantly lower viscosity when compared to the adhesives of Comparative Examples 1 and 3. Comparative Example 3, in particular, shows that high diblock content of the rubber significantly increases the viscosity of the adhesive to an unusable state, when an aromatic tackifier is also present. Examples 1 and 2 show that the phase separation keeps viscosities similar to the viscosity of Example 1, despite different diblock content in the rubber and different loadings of aromatic tackifier, oil-based plasticizer, and aliphatic tackifier.

The foregoing examples and embodiments were presented for illustrative purposes only and not intended to limit the scope of the invention.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

What is claimed is:

1. A hot-melt pressure-sensitive adhesive composition, comprising:
a styrenic block copolymer having a diblock content between about 5% and about 40% by weight of the styrenic block copolymer;
an aliphatic tackifier that associates with a mid-block of the styrenic block copolymer;
an oil-based plasticizer; and
an aromatic tackifier that associates with an end-block of the styrenic block copolymer and induces phase separation in the adhesive composition,
wherein a phase-separated morphology of the hot-melt pressure-sensitive adhesive composition comprises at least two distinct domains,
wherein the hot-melt pressure-sensitive adhesive composition has an operable temperature window between about 5° F. and about 140° F.

2. The adhesive composition of claim 1, wherein the aromatic tackifier is a C9 tackifier.

3. The adhesive composition of claim 1, wherein the aromatic tackifier is an alpha methyl styrene tackifier.

4. The adhesive composition of claim 1, wherein the aliphatic tackifier is a C5 tackifier.

5. The adhesive composition of claim 1, wherein the aliphatic tackifier is substantially devoid of aromatic modifications.

6. The adhesive composition of claim 1, wherein the styrenic block copolymer is a styrene-isoprene-styrene block copolymer.

7. The adhesive composition of claim 6, wherein the styrene-isoprene-styrene block copolymer has a melt flow index of about 8-28, a styrene content of about 10-30%, and a diblock percentage at or below about 38% by weight of the styrene-isoprene-styrene block copolymer.

8. The adhesive composition of claim 1, wherein the diblock content of the styrenic block copolymer is between about 15% and about 38% by weight of the styrenic block copolymer.

9. The adhesive composition of claim 1, wherein the operable temperature window is about 15-120° F.

10. The adhesive composition of claim 1, wherein the oil-based plasticizer is an aliphatic plasticizer chosen from paraffinic oils, naphthenic oils, mineral oils, and a combination thereof.

11. The adhesive composition of claim 1, wherein
the styrenic block copolymer is about 10-50% by weight of the composition;
the aromatic tackifier is between about 1% and about 15% by weight of the composition,
the aliphatic tackifier is between about 35% and about 55% by weight of the composition, and
the oil-based plasticizer is between about 15% and about 25% by weight of the composition.

12. The adhesive composition of claim 1, wherein the aromatic tackifier has a softening point that is higher than a softening point of the aliphatic tackifier.

13. The adhesive composition of claim 12, wherein the aliphatic tackifier has a softening point of about 10-120° C. and the aromatic tackifier has a softening point of about 50-250° C.

14. The adhesive composition of claim 1, further comprising an antioxidant and a stabilizer in an amount of about 0.1%-2% by weight of the composition.

15. The adhesive composition of claim 1, wherein the adhesive composition has the following properties:
a constant load debonding rate between about 0.001 in/min and about 0.03 in/min, acquired with a 180° peel orientation at 120° F. under a constant load of about 150 grams per inch of width; and
a peel adhesion between about 3 lbs/in and about 30 lbs/in at 25° F.

16. The adhesive composition of claim 15, wherein the peel adhesion comprises T-peel adhesion, acquired according to modified ASTM D1876 at a run rate of 2 inches/min, about 15 minutes after an adhesive bond is formed, at 25° F.

17. The adhesive composition of claim 15, wherein the peel adhesion comprises bond to concrete peel adhesion, acquired according to modified ASTM D903, with an average peel angle of 90°, at 25° F.

18. The adhesive composition of claim 15, wherein the composition has an average melt viscosity of about 2000-5000 cP at 350° F. and/or an average melt viscosity of about 6000-15000 cP at 300° F., acquired at a temperature between 250-400° F. on a parallel plate rheometer operating in steady state flow mode from shear rates of 0.1-100 l/s.

19. A hot-melt pressure-sensitive adhesive composition, comprising a styrenic block copolymer, at least one tackifier, and a plasticizer, wherein the pressure-sensitive adhesive composition has the following properties:
a constant load debonding rate of 0.001 in/min and about 0.03 in/min, acquired with a 180° peel orientation at 120° F. under a constant load of about 150 grams per inch of width; and
a peel adhesion between about 3 lbs/in and about 30 lbs/in at 25° F.

20. The adhesive composition of claim 19, wherein the styrenic block copolymer has a diblock content between about 15% and about 38% by weight of the styrenic block copolymer.

21. The adhesive composition of claim 19, wherein the peel adhesion comprises T-peel adhesion, acquired according to modified ASTM D1876 at a run rate of 2 inches/min, about 15 minutes after an adhesive bond is formed, at 25° F.

22. The adhesive composition of claim 19, wherein the peel adhesion comprises bond to concrete peel adhesion, acquired according to modified ASTM D903, with an average peel angle of 90°, at 25° F.

23. The adhesive composition of claim 19, wherein the composition has a melt viscosity of about 2000-5000 cP at 350° F. and/or a melt viscosity of about 6000-15000 cP at 300° F., acquired at a temperature between 250-400° F. on a parallel plate rheometer operating in steady state flow mode from shear rates of 0.1-100 l/s.

24. A waterproofing product, comprising the hot-melt pressure-sensitive adhesive composition of claim 1.

25. A waterproofing product, comprising the hot-melt pressure-sensitive adhesive composition of claim 19.
